(19) United States
(12) Patent Application Publication
(10) Pub. No.: US 2010/0011314 A1
(43) Pub. Date: Jan. 14, 2010

(54) System, method and computer-readable medium for providing a sidebar functionality as an aspect of a gadget

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/217,904

(22) Filed: Jul. 9, 2008

(51) Int. Cl. G06F 3/048

(52) U.S. Cl. 715/779; 715/846

(57) ABSTRACT

A system, method and computer-readable media for associating additional fuctionalities with a sidebar GUI of a computational device are included. An operating system may be provided that includes a sidebar software that will typically have limitations that are intended or unintended by the operating system developer. A user may wish to extend the capabilities that are associated with the sidebar in the interest of usability, efficiency and/or GUI appeal. The method of the present invention may provide a gadget which enables access to the sidebar, while associating additional capabilities with the sidebar. Alternately or additionally, a reseller of the operating system or a third party software provider, may offer software products that enable access to the functionality of the sidebar as provided by the sidebar developer, while associating additional capabilities with a display of the sidebar or an icon representative of a sidebar or sidebar functionality.

### FIELD OF THE INVENTION

The present invention relates to information technology systems that enable a user to receive information via an electronics communications network. The present invention more particularly relates to enabling a user of an information technology system to personalize or customize a graphical user interface of an information technology system.

### BACKGROUND OF THE INVENTION

The prior art provides numerous electronic information technology systems that enable a user to download information from an electronics communications network, such as the Internet or a wireless telephony network, include an enabling graphical user interface. These prior art network-enabled information technology systems include cellular telephones, personal computers, wireless communications enabled personal digital assistants and other wireless enabled electronic devices that may be further configured to visually display information accessible via a telephony network, a wireless telephony network, a computer network, and/or the Internet. It is understood that accessibility to the Internet may include accessibility to the World Wide Web.

Most network-enabled, electronic information technology systems (hereafter, “IT systems”) include an operating system that supports a graphical user interface. The graphical user interface may include a plurality of visual icons, by means of which a user may select an applications program to begin or continue to run or operate. The user selection means may include a point and click device, such as a computer mouse, or a trackball.

The prior art further provides graphical user interfaces (hereafter, “GUI's) that organize or associate icons within contextualizing presentations, such as dashboards or sidebars. The Windows Vista Operating System™, a personal computer operating system marketed by Microsoft Corporation, includes a sidebar in a desktop GUI that can offer icons to select eleven sidebar software gadgets, i.e., a calendar application, clock display, a contacts program, a CPU meter display, a currency conversion, an RSS feed headlines, a notes application, a picture puzzle program, a slide show program, a financial securities information display program, and a weather information display. Of these eleven gadgets, the clock, the slide show and RSS feed headlines displays are displayed by default on a new installation of Windows Vista. Microsoft Corporation further provides a link to a web site called Windows Live Gallery where additional sidebar gadgets that have been created by third party clients can be downloaded.

A software gadget (hereafter, “gadget”) is a specific purpose software application that can sit on the user's computer desktop, or be hosted on a web page. Web gadgets can run on a web site, such as the website www.Live.com and at the website www.Spaces.Live.com. A sidebar gadget may run on, and be displayed within, a desktop GUI, such as the Windows Sidebar™ GUI element. Sideshow gadgets run on auxiliary external displays, such as on the outside of a laptop computer or even on an LCD panel in a keyboard, and potentially mobile cellular phones and other IT systems.

Desktop gadgets are desktop widgets, i.e., specialized software applications that are designed to do various tasks, such as track and display a time value, a calendar function, an RSS notifier, or a search tools. Certain software operating systems, e.g. Windows Vista™ personal computer software operating system, can run on a desktop and in association with a sidebar.

The Windows Sidebar™ software and image generated therefrom may be visually presented as a panel found in either the right side (default) or the left side of the Windows Desktop™ GUI. The Windows Sidebar™ software is integrated within the Windows Vista™ operating system, a version of the Microsoft Windows™ operating system. The Windows Sidebar™ GUI software is a widget engine that manages and enables Desktop Gadgets™ application software. Microsoft Desktop Gadgets™ are software applications which can be used to simultaneously display different information such as the system time, Internet-powered features such as RSS feeds, and to control external software applications, such as the Windows Media Player™ video data rendering software application.

The prior art thus provides GUI sidebars that enable access to software gadgets and widgets under limitations imposed by the sidebar design. Each of these limitations may be intended or unintended, and/or explicit or implicit. Given the availability of software gadgets and software widgets as provided by the many competing computer software developers, to include open source software developers, there is a clear need in the market to both enable sidebar functionality to the fullest extent made possible by the provider of the software, as well as enhance or associate with a sidebar additional functionalities beyond those enabled by the sidebar software as provided from the developer or a marketer of the sidebar.

### SUMMARY OF THE INVENTION

Towards this object and other objects that will be made obvious in light of this disclosure, a first version of the method of the present invention provides a system for a software architecture configured for integrating a sidebar into a software process, e.g. a software gadget, wherein the architecture comprises or enables: (a.) a sidebar software configured to display a sidebar within a visual display of an informational system; (b.) a software process configured to present the sidebar in association with a visually displayed gadget or software widget and to enable actuation of at least one sidebar functionality and at least one additional functionality; and (c.) a graphics generator configured to render the sidebar in association with a software process, such as a software widget or a software gadget.

The invented architecture may additionally or alternatively include a cover flow generator, the cover flow generator configured for rendering a plurality of visual icons and wherein each visual icon enables actuation of at least one functionality associated with a software process.

The actuation of a functionality of the invented software process may include or consist of: (a.) placing a sidebar to a foreground of the desktop image; (b.) placing a comprising icon enabling execution of the invented software process to a foreground of the desktop image, whereby the sidebar is optionally displayed within the comprising icon of the invented software process; (c.) enabling actuation of a sidebar functionality; (d.) running a software application or process associated with the at least one visual icon; and (e.) placing a contemporaneously open software application to a foreground of the desktop image.

A visual icon of the invented software process may enable actuation of (a.) a sidebar; (b.) a functionality of the sidebar; and (c.) an additional functionality associated with the gadget and not made available by the sidebar.

The method of the present invention additionally or alternatively enables a user to add to a functionality suite of a sidebar gadget by directing an IT system to (a) render a gadget image within a desktop image of a display device, the gadget image and/or widget images enabling actuation of a sidebar set of functionality and at least one functionality; (b.) display at least one widget icon within the desktop. The user may, in certain versions or applications of the method of the present invention, be enabled by the IT system to drag and drop the widget icon into the gadget image and direct the IT system to include the at least one widget icon within the gadget image, whereby a widget functionality associated with the widget icon may be actuated by means of the sidebar gadget.

Certain alternate preferred embodiments of the method of the present may further include one or more of the following aspects: (a.) displaying a plurality of widget icons within the desktop image; (b.) enabling the user to drag and drop any of the widget icons into the gadget image and in response including a dragged and dropped widget icon within the gadget image, whereby a widget functionality associated with any dragged and dropped widget icon of the gadget image may be actuated by means of the sidebar gadget; (c.) associating at least one functionality of the sidebar set of functionality, wherein the at least one gadget functionality and at least one widget functionality in a unique one to one correspondence with a cover icon of plurality of cover icons; (d.) rendering the plurality of cover flow icons as a cover flow view within the desktop image; (e.) rendering the plurality of function icons and the at least one widget icon as unique icon views within the gadget image; and/or (f.) rendering the plurality of text tags as a list view within the gadget image.

Certain still alternate preferred embodiments of the method of the present invention provide a computational system that includes (a.) means to visually display a gadget; (b.) means to display a sidebar as an aspect of the gadget; (c.) means to enable a user to select a functionality from the gadget; (d.) means to render a cover flow view from which each functionality of a plurality of functionalities of the sidebar and the gadget may be selected and actuated by a user; and/or (e.) means to enable a user to add a functionality to the gadget by dragging and dropping a function icon associated with the functionality into a visual display of the gadget.

Certain yet alternate preferred embodiments of the method of the present invention provide a computer-readable medium comprising machine-readable instructions which when executed by a computational system cause the computational system to perform a method that includes the aspects of visually associating a sidebar as an aspect of gadget; and/or visually associating access to at least one additional functionality as an aspect of the gadget.

The foregoing and other objects, features and advantages will be apparent from the following description of the preferred embodiment of the invention as illustrated in the accompanying drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Pat. No. 6,850,949 (Warner, et al.; Issued Feb. 1, 2005) entitled “System and method for generating a dynamic interface via a communications network”; U.S. Pat. No. 7,185,290 (Cadiz, et al.; Issued Feb. 27, 2007) entitled “User interface for a system and process for providing dynamic communication access and information awareness in an interactive peripheral display”; and U.S. Pat. No. 7,313,760 (Grossman, et al.; Issued Dec. 25, 2007) entitled “Contact picker” are incorporated herein by reference in their entirety and for all purposes. In addition, United States Patent Application Publication No. 20080034381 (Jalon, Julien, et al.; Published Feb. 7, 2008) entitled “Browsing or Searching User Interfaces and Other Aspects”; United States Patent Application Publication No. 20070044039 (Amadio, Louis, et al.; Published Feb. 22, 2007) entitled “Sidebar engine, object model and schema”; United States Patent Application Publication No. 20070226734 (Lin, Yu-Kuan, et al.; Sep. 27, 2007) entitled “Auxiliary display gadget for distributed content”; United States Patent Application Publication No. 20070198946 (Viji, Sriram, et al.; Aug. 23, 2007) entitled “Auxiliary display sidebar integration”; United States Patent Application Publication No. 20080022224 (Coutts; Daryl David; Published Jan. 24, 2008) entitled “Pushed and pulled information display on a computing device”; United States Patent Application Publication No. 20070263255 (Johnson, Neil, et al.; Published Nov. 15, 2007) entitled “System and method for remote monitoring of print systems”; United States Patent Application Publication No. 20070214430 (Coutts, Daryl David; Published Sep. 13, 2007) entitled “Textpane for pushed and pulled information on a computing device”; United States Patent Application Publication No. 20070074126 (Fisher, Oliver, et al.; Published Mar. 29, 2007) entitled “Sidebar engine, object model and schema”; United States Patent Application Publication No. 20070044035 (Amadio, Louis, et al.; Published Feb. 22, 2007) entitled “Docking and undocking user interface objects”; United States Patent Application Publication No. 20070044029 (Fisher, Oliver, et al.; Feb. 22, 2007) entitled “Sidebar engine, object model and schema”; and United States Patent Application Publication No. 20070043839 (Amadio, Louis, et al.; Published Feb. 22, 2007) entitled “Installing data with settings” are incorporated herein by reference in their entirety and for all purposes.

### BRIEF DESCRIPTION OF THE DRAWINGS

These, and further features of the invention, may be better understood with reference to the accompanying specification and drawings depicting the preferred embodiment, in which:

FIG. 1 is an illustration of a screen shot of a video display of a computational system;

FIG. 2 is an illustration of a second screen shot of the video display 4 of FIG. 1, wherein a first invented sidebar GUI is displayed;

FIG. 3 is a schematic of the computational system of FIGS. 1 and 2;

FIG. 4 is an illustration of a first invented software architecture of the device of FIGS. 1-3 and that enables a rendering of the first sidebar of FIG. 2;

FIG. 5 is an illustration of an exemplary personalized sidebar record of the first architecture of FIG. 4;

FIG. 6 is a flowchart of a first optional aspect of the method of the present invention;

FIG. 7 is a flowchart of a second optional aspect of the method of the present invention;

FIG. 8 is a flowchart of a third optional aspect of the method of the present invention;

FIG. 9 is a flowchart of a fourth optional aspect of the method of the present invention; and

FIG. 10 is a flowchart of a method of dragging and dropping an icon of FIGS. 1 through 9 into the first sidebar of FIGS. 2 through 9 and thereby including a reference a gadget, widget or sidebar software program of FIG. 4 by inclusion within the configuration record of FIG. 4.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar object.

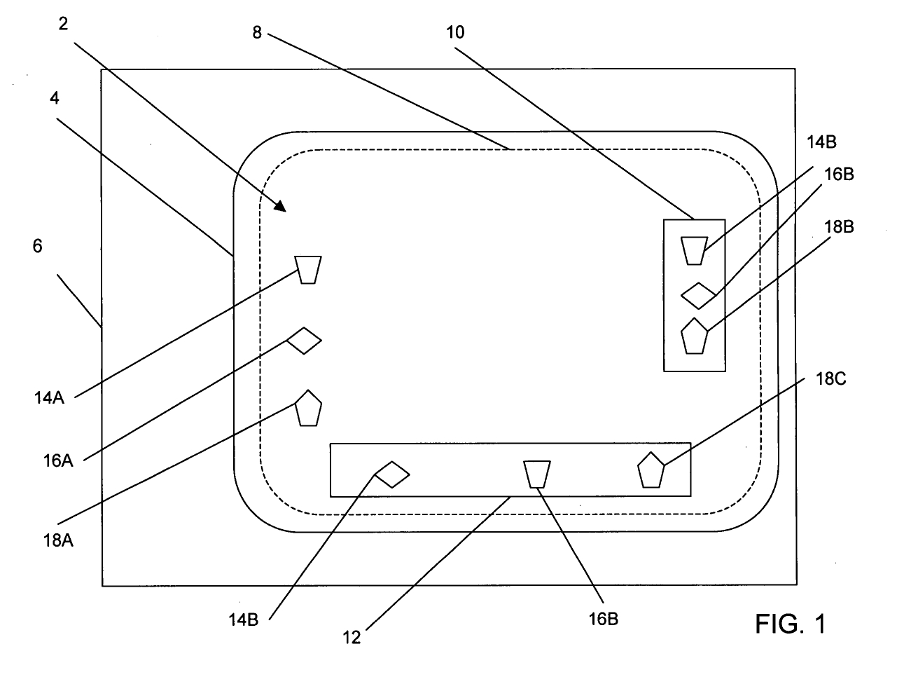

Referring now generally to the Figures and particularly to FIG. 1, FIG. 1 is an illustration of a screen shot 2 of a video display 4 of a computational system 6. The video display 4 presents a variety of prior art graphical user interfaces (“GUI's”), to include a desktop GUI 8 (hereafter, “desktop” 8) having a prior art sidebar GUI 10 (hereafter, “sidebar” 10) and an applications bar GUI 12 (hereafter, “apps bar” 12). The video display 4 additionally displays a plurality of gadget icons 14A-14X, widget icons 16A-16X and application software icons 18A-18X within the desktop 8, the sidebar 10 and the apps bar 12. It is understood that one or more gadget icons 14A-14X, widget icons 16A-16X and application software icons 18A-18X may be associated with and/or displayed within the sidebar 10 or the apps bar 12.

It is understood that a user may direct the computational system 6 to initiate a web service, a communications session, or a computational process by selecting an icon 14A-14X, 16A-16X, or 18A-18X associated with the selected icon.

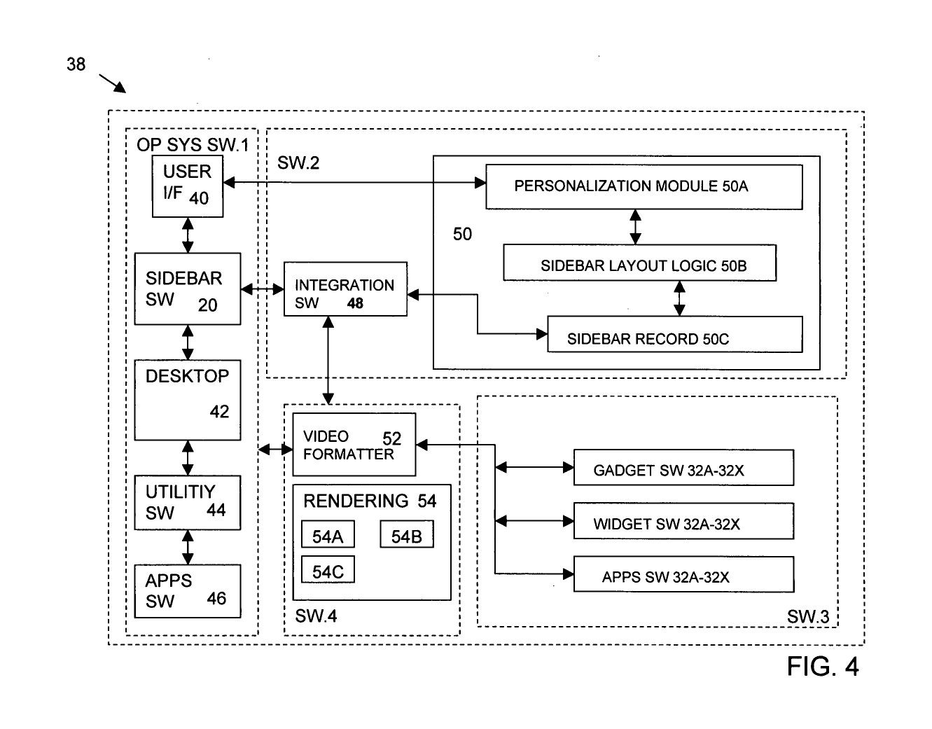

In the prior art sidebar 10 may allow a user or other third party to select and associate one or more gadget icons 14A-14X, widget icons 16A-16X or applications icon 18A-18X in accordance with certain restrictions, limitations and constraints imposed by prior art sidebar software 20 (as per FIG. 4).

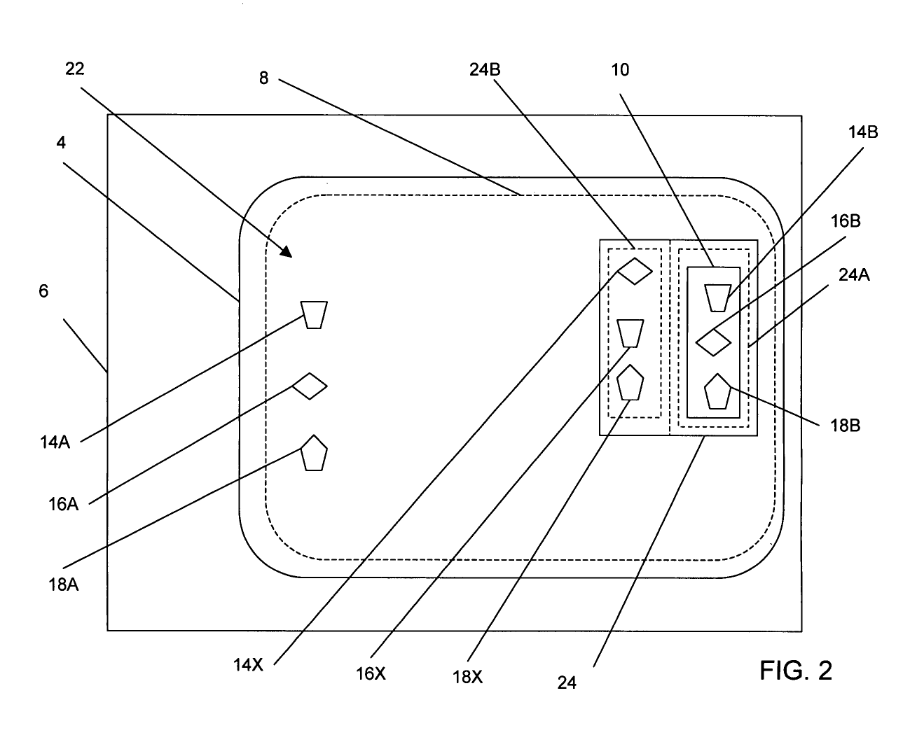

Referring now generally to the Figures and particularly to FIG. 2, FIG. 2 is an illustration of a second screen shot 22 of the video display 4 of FIG. 1, wherein a first invented sidebar GUI 24 (hereafter, “first sidebar” 24) is displayed. The first sidebar 24 is a software gadget icon that presents the prior art sidebar 10 within a first display area 24A and further displays one or more other icons 14X, 16X & 18X within a second display area 24B. The first sidebar 24 expands the opportunity for associating additional functionalities with the prior art sidebar 10 and the prior art sidebar 10 is comprised as an aspect of the first sidebar 24. The first sidebar 24 is instantiated by the device 6 when the user selects a first sidebar icon 24C.

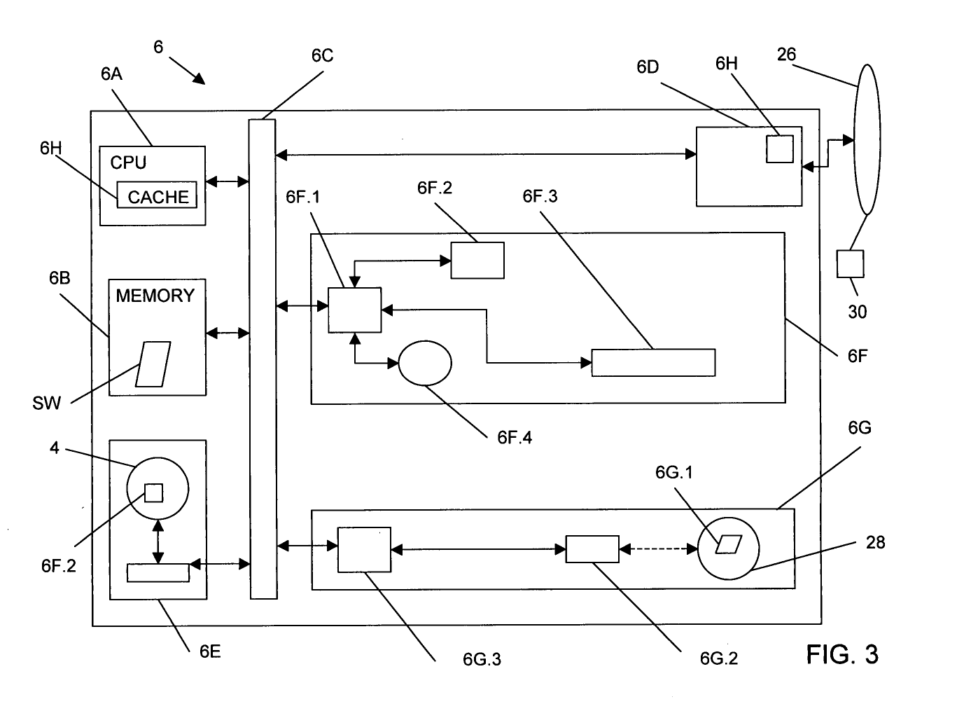

Referring now generally to the Figures and particularly to FIG. 3, FIG. 3 is a schematic of the computational system 6 of FIGS. 1 and 2. The computational system 6 (hereafter, “device” 6) may be or comprise a personal computer, a personal digital assistant (“PDA”), a wireless communications enabled PDA, a digital telephone, and/or a digital cellular telephone. Examples of embodiments of device 6 may include (1.) a Nokia Model E61™ cellular telephone marketed by Nokia Corporation of Espoo, Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y., (4.) a Powerbook G4™ laptop personal computer marketed by Apple Computer of Cupertino, Calif.; or (5.) other suitable computational system known in the art, and optionally configured for wireless and/or landline connectivity with the Internet and/or the World Wide Web.

The device 6 includes a central processing unit 6A (hereafter, “6A”) and a system memory 6B. An internal communications bus 6C enables bi-directional communications among the CPU 6A, the system memory 6B, a network interface 6D, a video display module 6E, a user input module 6F, a media reader module 6G of the device 6. A system software SW is stored within the system memory 6B and may partially and/or temporarily be stored within the CPU 6A and/or a cache memory 6H of the CPU 6A.

The network interface 6D may comprise a wireless communications module 6H that enables bi-directional communications with a wireless telephony network, a wireless computer communications network, or the Internet. The network interface 6D is configured to bi-directionally communicatively couple the device 6 with an electronics communications network 26 (hereafter, “network” 26). The network 26 may be or comprise a computer network, a wireless computer communications network, a telephony network, a wireless telephony network, and/or the Internet.

The user input module 6F may include an input interface 6F.1, a touch screen circuitry 6F.2, a digital keyboard 6F.3 and a point and click device 6F.4. The point and click device 6F.4 may be a computer mouse, computer peripheral trackball or other suitable computer selection input device or circuit known in the art. The touch screen circuitry 6F.2, the digital keyboard 6F.3 and the point and click device 6F.4 provide electrical or digital electronic signals to the input interface 6F.1. The input interface 6F.1 interprets the information transmitted in the signals received from the touch screen circuitry 6F.2, the digital keyboard 6F.3 and the point and click device 6F.4 and transmits the information interpretations in messages transmitted via the internal communications bus 6C to the CPU 6A.

The video display module 6E includes a video display 4, a display interface 6E.1, and optionally the touch screen circuitry 6F.2. The display interface 6E.1 is bi-directionally communicatively coupled the internal communications bus 6C and receives image rendering instructions therefrom. The display interface 6E.1 interprets the image rendering instructions received from the internal communications bus 6C and includes information derived from the image rendering instructions into image rendering messages, and provides the image rendering messages to the video display 4. The video display 4 renders the desktop 8, the sidebar 10, the apps bar 12, the first sidebar 24, and/or icons 14A-18X as directed by the image rendering messages.

It is understood that various embodiments of the device 6 may comprise other suitable data input and data display module, devices and circuits known in the art, and as found in the examples of devices 6 noted herein.

The media reader module 6G of the device 6 is configured to read machine-readable, software encoded instructions 6G.1 from a computer-readable media 28. The machine-readable, software encoded instructions 6G.1 that may be read by the media reader module 6G may direct the device 6, or enable the device 6, to execute or instantiate one or more aspects of the method of the invention. The reader sensor 6G.2 is configured and selected to read, and optionally to write, machine-readable, software encoded instructions 6G.1 to or from the computer-readable media 28 and provide the software encoded instructions 6G.1 to a media reader interface 6G.3 of the media reader module 6G. The media reader interface 6G.3 is bi-directionally communicatively coupled with the internal communications bus 6C and provides software encoded instructions 6G.1 to the CPU 6A and system memory 6B via the internal communications bus 6C.

The terms “computer-readable medium” and “computer-readable media” 28 as used herein refer to any suitable medium known in the art that participates in providing software-encoded instructions 6G.1 to the network 26 and/or the device 6. Such a medium 28 may take many forms, including but not limited to, non-volatile media, volatile media, and transmission media. Non-volatile media includes, for example, optical or magnetic disks, such as may be comprised within the system memory.

Volatile media includes dynamic memory. Transmission media includes coaxial cables, copper wire and fiber optics. Transmission media can also take the form of acoustic or light waves, such as those generated during radio wave and infrared data communications.

Common forms of computer-readable media 28 include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a device 6 can read.

Various forms of computer-readable media 28 may be involved in carrying one or more sequences of one or more software-encoded instructions 6G.1 to the network 26 for execution. For example, the software-encoded instructions 6G.1 may initially be carried on a magnetic disk of a remote server 30. The remote server 30 can load the software-encoded instructions 6G.1 into its dynamic memory and send the instructions 6E.1 the device 6 via network 26. The remote server may be or comprise (1.) a SUN SPARCSERVER computer workstation marketed by Sun Microsystems of Santa Clara, Calif. running LINUX™ or UNIX™ operating system; (2.) a personal computer configured for running WINDOWS XP™ operating system marketed by Microsoft Corporation of Redmond, Wash.; (3.) a personal computer configured for running MAC OS 10™ operating system as marketed by Apple Computer of Cupertino, Calif.; or (4) an iPhone™ cellular telephone as marketed by Apple Computer of Cupertino, Calif.

The remote server 30 and the computer-readable media 28 may additionally or alternatively provide a gadget software 32, a widget software 34 and/or an application software 36 to the device 6 (as shown in FIG. 4). The CPU 6A, the system memory 6B, the internal communications bus 6C, the user interface module 6E, and the network interface 6D enables the device 6 to accept and execute user commands that require the device 6 to establish a communications session with the remote server 6 in order to provides a functionality offered by at least one gadget software 32, widget software 34 and/or application software 36. It is further understood that one or more gadget software 32, a widget software 34 and/or an application software 36 may require communication with the remote server 30 or the network 26 in order to best or consistently provide functionality to the device 6. 20. The gadget software 32, widget software 34 and/or application software 36 provide software code that enables the device at least partially satisfy at least one user command that requires the system to establish a communications session with the remote server 30 while the device 6 is offline, i.e., not in communication with the server 30.

It is understood that the definition of the term application software 36 as used within the present disclosure includes computer utility software programs, communications software programs, and consumer applications software programs.

Referring now generally to the Figures and particularly to FIG. 4, FIG. 4 is an illustration of a first invented software architecture 38 of the device 6 that enables a rendering of the first sidebar 24. The first invented software architecture 38 (hereafter, “first architecture”) is comprised within the system software SW and may be applied to render the first sidebar 24 in association with the sidebar 10 on the video display device 6E.1. The prior art side bar 10 may generated by the prior art sidebar software 20 that may be included within an operating system software SW.1.

The operating system software SW.1 (hereafter, “op sys” SW.1) may be (1.) a UNIX™ operating system supported by the Open Group of San Francisco, Calif.; (2.); a LINUX™ operating system as marketed by Red Hat, Inc. of Raleigh, N.C.; (2.) a WINDOWS VISTA™ OR WINDOWS XP™ operating system marketed by Microsoft Corporation of Redmond, Wash.; or (3.) a MAC OS 10™ operating system as marketed by Apple Computer of Cupertino, Calif.

The ops sys SW.1 includes a user interface module 40, the sidebar software 20, a desktop software 42, and various utility software programs 44 and applications software programs 46. The user interface software module 40 enables the device 6 to accept, interpret and operate as directed by commands and data provided by the user via the user input module 6F.

A first sidebar software module SW.2 includes an integration module 48 and a first sidebar generator 50. The first sidebar generator 50 comprises software code that enables and directs the device 6 to render the first sidebar 24. A personalization module 50A of the first sidebar generator 50 enables the device 6 to accept user commands and data from the user interface module 40 that are interpreted by a layout logic module 50B to generate a personalized sidebar record 50C. The integration module 48 accepts both (a.) the personalized sidebar record 50C, and (b.) information describing a rendering of the prior art sidebar 10 as generated by the sidebar software 20.

The first sidebar software module SW.2 enables the device 6 to accept and attempt to respond to requests from a user for functionality provided by gadget software programs 32A-32X, widget software programs 34A-34X and application software programs 36A-36X that are referenced in the personalized sidebar record 50C. It is understood that the device 6 may operate in an online mode when bidirectionally coupled with the network 26 and/or the server 30, and in an offline mode when the device 6 is not bidirectionally coupled with the network 26 and/or the server 30.

A program library SW.3 includes gadget software programs 32A-32X, widget software programs 34A-34X and application software programs 36A-36X. Each gadget software program 32A-32X, widget software program 34A-34X and application software program 36A-36X enables a rendering of an individual icon 14A-14X, 16A-16X, or 18A-18X.

A rendering module SW.4 includes a video formatting program 52 and a rendering engine 54. The video formatting program 52 receives rendering integration instructions from the integration module 48, the sidebar software 20, a desktop software 42, and one or more gadget software programs 32A-32X, widget software programs 34A-34X and/or application software programs 36A-36X. The rendering engine 54 provides information that directs the video display module 6E to visually render the first icon 24 and the prior art icon 20 within first display area 24A, and one or more other program icons 14A-14X, 16A-16X, and/or 18A-18X in the first display icon 24B.

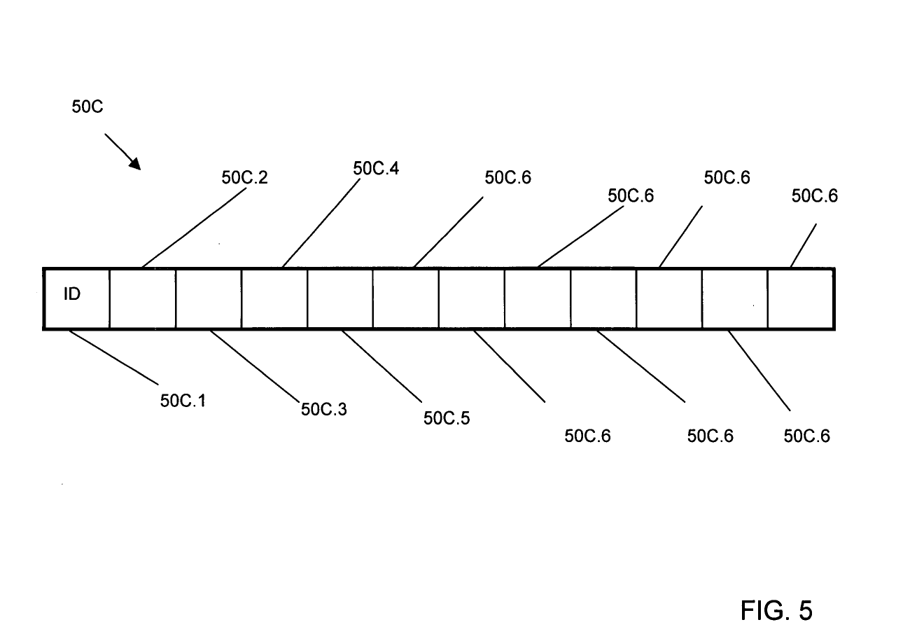

Referring now generally to the Figures and particularly to FIG. 5, FIG. 5 is an illustration of an exemplary personalized sidebar record 50C of the first architecture of FIG. 4. The sidebar record 50C includes a first sidebar record identifier 50C.1, a first sidebar icon code 50C.2, a first layout specification software code 50C.3 for the first display area 24A, a second layout specification software code 50C.4 for the second display area 24B, a reference to the prior art sidebar icon 50C.5, and one or more identifiers 50C.6 of additional gadget software 32, widget software 34 or application software 36. The integration module 48 accepts the sidebar record 50C and integrates rendering information from the sidebar software 20, the desktop software 42, and other software programs 32, 34 & 36 referenced by the sidebar record 50C.

The integration software module applies (a.) the first sidebar icon code 50C.2 to generate the first sidebar 24; (b.) the first layout specification software code 50C.3 to size, shape and direct the device 6 to render the first display area 24A; (c.) the second layout specification software code 50C.4 to size, shape and direct the device 6 to render the second display area 24B; (d.) the reference to the prior art sidebar icon 50C.5 to direct the device 6 to render the prior art sidebar 10 within the first display area 24A of the first icon 24; and (e.) one or more identifiers 50C.6 to direct the device 6 to render icons 14A-X, 16A-X and/or 18A-X within the second display area 24B.

The rendering engine 54 optionally includes a cover flow generator 54A, a layering engine 54B and a list view generator 54C. The cover flow generator 54A enables the icons 14A-14X, 16A-16X, and 18A-18X and the prior art icon 20 to be visually presented as a dynamic cover flow image. The definition of the term cover flow as applied within the present disclosure describes a three-dimensional graphical user interface included with iTunes™ digital music record player, the Macintosh Finder™ software menu organizer, and other products for enabling a user to visual rummaging through pluralities of software programs and digital media libraries by displaying visual image icons 14A-14X, 16A-16X, and 18A-18X.

The layering engine 54B organizes the icons 20, 24, 24C, 14A-14X, 16A-16X, and 18A-18X in order from a background to a foreground. The user may direct the device 6 to apply the layering engine to place each displayed icon 20, 24, 24C, 14A-14X, 16A-16X, and 18A-18X in one or more ordered layers between and including a background layer and a foreground layer.

The list view generator 54C presents textual labels of software programs 32, 34 & 36 via the video display 4 and enables selection of each listed software program 32, 34 & 36 by means of the user input module 6F.

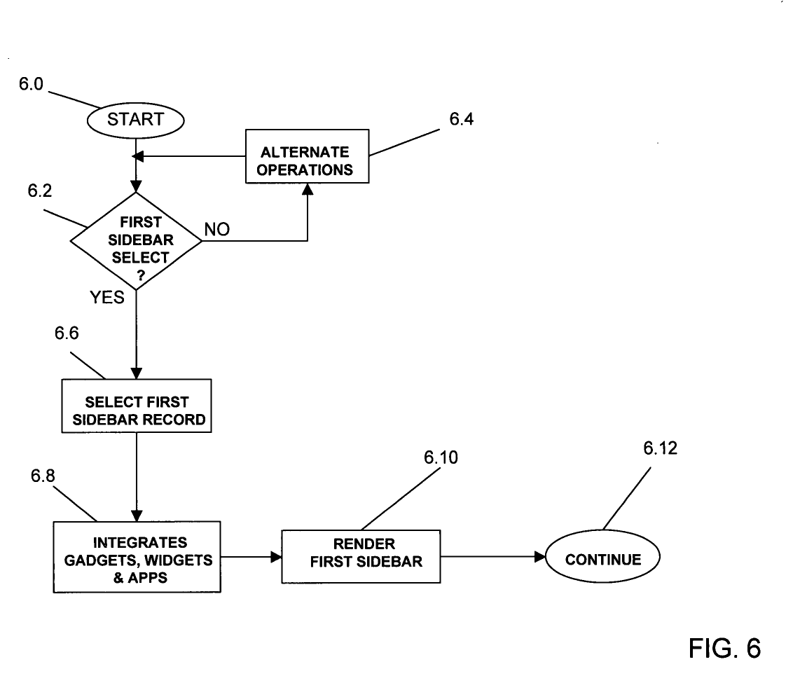

Referring now generally to the Figures and particularly to FIG. 6, FIG. 6 is a flowchart of a first optional aspect of the method of the present invention, wherein the first sidebar icon 24C is selected by the user by means of the input module 6F in step 6.2. When the first sidebar icon 24C is not selected in step 6.2, the device 6 proceeds on from step 6.2 to perform alternate operations in step 6.4. The device 6 selects the personalized sidebar record 50C in step 6.6 and integrates the rendering information of the personalized sidebar record 50C, the prior art sidebar program 20, and one or more additional software modules 32, 34 and/or 36 to in step 6.8. In step 6.10 the first sidebar 24 is rendered, wherein the prior art sidebar 20 is displayed within the first display area 24A and one or more icons 14A-14X, 16A-16X, and/or 18A-18X are rendered in the second display area. The device 6 proceeds from step 6.10 to step 6.12 to perform other operations, wherein one or more icon elements 20, 14A, 14B, 16A, 16B & 18A of the sidebar 24 may be selected so as to direct the device 6 to execute or run a software program associated with the selected icon or icons 20, 14A, 14B, 16A, 16B & 18A. It is understood that the device 6 may return from step 6.12 to step 6.2 periodically or upon receipt of a relevant command by the user or via the network 26.

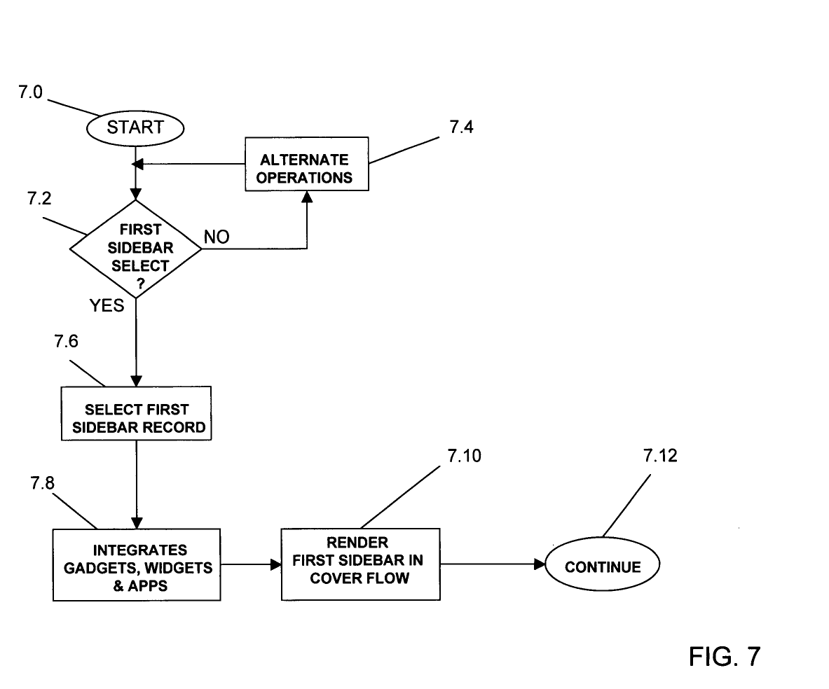

Referring now generally to the Figures and particularly to FIG. 7, FIG. 7 is a flowchart of a second optional aspect of the method of the present invention, wherein the first sidebar icon 24C is selected by the user by means of the input module 6F in step 7.2. When the first sidebar icon 24C is not selected in step 7.2, the device 6 proceeds on from step 7.2 to perform alternate operations in step 7.4. The device 6 selects the personalized sidebar record 50C in step 7.6 and integrates the rendering information of the personalized sidebar record 50C, the prior art sidebar program 20, and one or more additional software modules 32, 34 and/or 36 to in step 7.8. In step 7.10 the first sidebar 24 is rendered by means of the cover flow generator 54A, wherein the icon elements 20, 14A, 14B, 16A, 16B & 18A of the sidebar 24 are rendered on the display screen within a cover flow visualization. The device 6 proceeds from step 7.10 to step 7.12 to perform other operations, wherein one or more icon elements 20, 14A, 14B, 16A, 16B & 18A of the sidebar 24 may be selected so as to direct the device 6 to execute or run a software program associated with the selected icon or icons 20, 14A, 14B, 16A, 16B & 18A. It is understood that the device 6 may return from step 7.12 to step 7.2 periodically or upon receipt of a relevant command by the user or via the network 26.

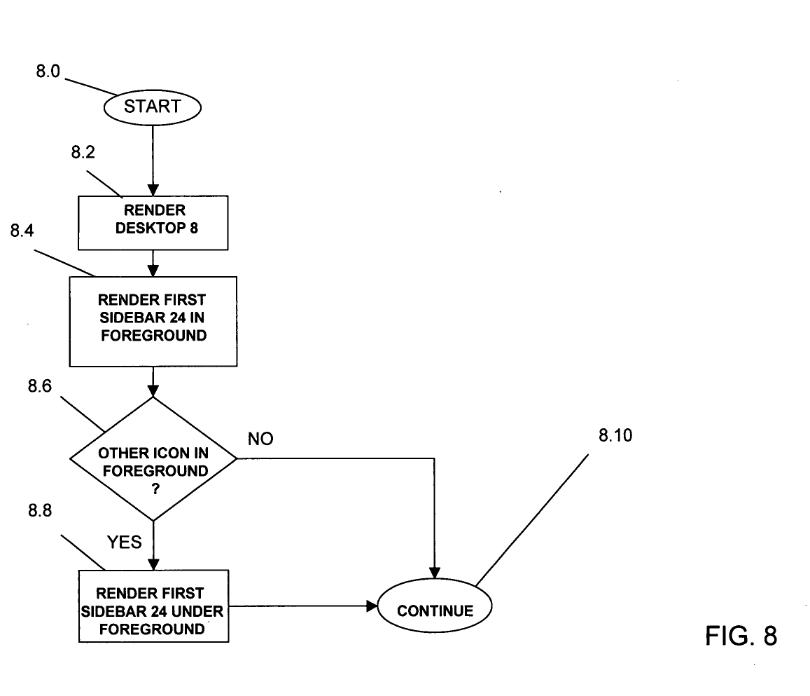

Referring now generally to the Figures and particularly to FIG. 8, FIG. 8 is a flowchart of a third optional aspect of the method of the present invention, wherein the desktop 8 is rendered step 8.2, and the first sidebar 24 is automatically rendered in a foreground layer as affected by the layering engine 54B step 8.4. The device 6 determines in step 8.6 whether another icon 14A-14X, 16A-16-X or 18A-X has been placed in the foreground by the layering engine 54B. When the device 6 determines in step 8.6 that an other icon 14A-14X, 16A-16-X or 18A-X had been placed in the foreground, the device 6 proceeds from step 8.6 to step 8.8, wherein the layering engine 54B places the first sidebar 24 into a layer lower than the foreground, e.g. a background layer. The device 6 proceeds from either step 8.6 or step 8.8 to step 8.10 to perform other operations. It is understood that the device 6 may return from step 8.10 to step 8.2 periodically or upon receipt of a relevant command by the user or via the network 26.

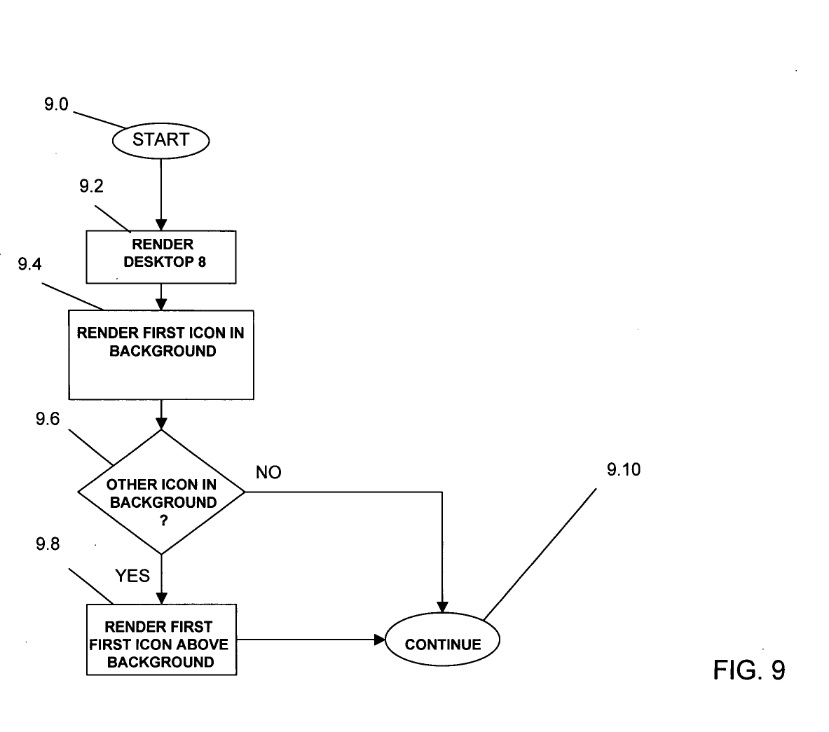

Referring now generally to the Figures and particularly to FIG. 9, FIG. 9 is a flowchart of a fourth optional aspect of the method of the present invention, wherein the desktop 8 is rendered step 9.2, and a first icon, e.g. a widget 16A, is automatically rendered in a background layer as affected by the layering engine 54B step 9.4. The device 6 determines in step 9.6 whether another icon 14A-14X, 16B-16-X or 18A-X has been placed in the background by the layering engine 54B. When the device 6 determines in step 9.6 that an other icon 14A-14X, 16B-16-X or 18A-X had been placed in the background, the device 6 proceeds from step 9.6 to step 9.8, wherein the layering engine 54B places the widget 16A into a layer higher than the background, e.g. a foreground layer. The device 6 proceeds from either step 9.6 or step 9.8 to step 9.10 to perform other operations. It is understood that the device 6 may return from step 9.10 to step 9.2 periodically or upon receipt of a relevant command by the user or via the network 26.

It further understood that the first sidebar 24, the gadgets 14A-14X, the widgets 16A-16X and the software applications 18A-18X may be moved from back ground to foreground, and within a plurality of layers between the background and the foreground, by the methods described in FIGS. 8 and 9, and/or by other suitable layering and ordering methods known in the art.

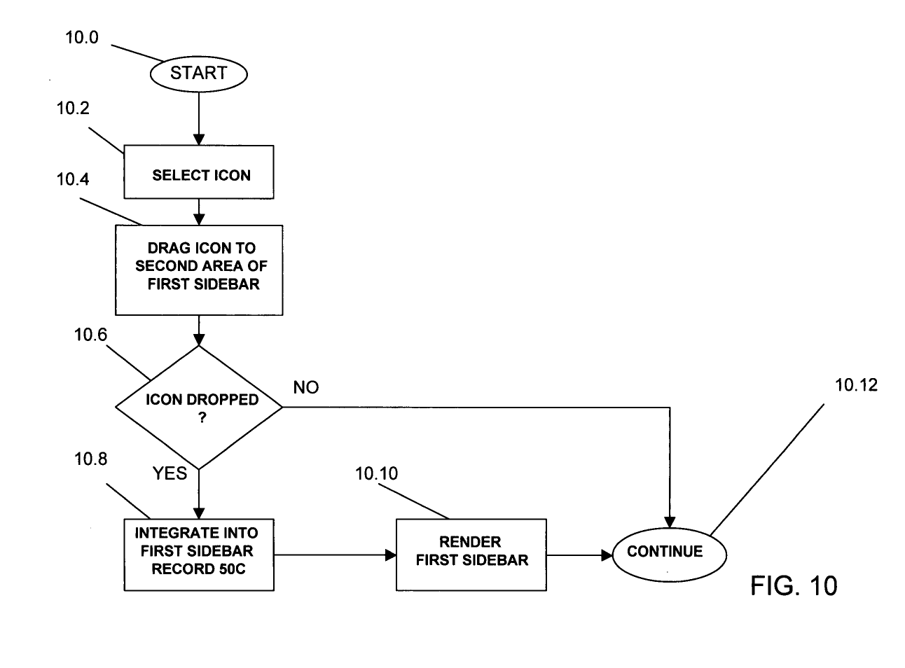

Referring now generally to the Figures and particularly to FIG. 10, FIG. 10 is a flowchart of a method of dragging and dropping an icon 14A-14X, 16A-16X, and or 18A-18X into the first sidebar 24 and thereby including a reference to a software program 32A-32X, 34A-34X or 36A-36X associated with the dropped icon 14A-14X, 16A-16X, and or 18A-18X within the configuration record 50C. For illustrative purposes, a first widget icon 14A will be discussed in a cycle of executing the flowchart of FIG. 10.

In step 10.2 a user selects the first gadget icon 14A by means of the user input module 6F and then drags the first gadget icon 14A by means of the user input module 6F to a location over the first sidebar icon 24 in step 10.4. The user may then drop the first gadget icon 14A by means of the user input module 6F, and the device 6 determines whether the first gadget icon 14A has been fully dragged and dropped into the first sidebar icon in step 10.6. When the device 6 determines that the first gadget icon 14A has been fully dragged and dropped into the first sidebar icon in step 10.6, the device 6 proceeds on from step 10.6 to step 10.8 to integrate a reference to the first widget software program 32A, whereby the logic module 50B is informed and directed to add the first gadget icon 14A into the first sidebar 24. In step 10.10 the device 6 renders an updated instantiation of the first icon 24, wherein the first gadget icon 14A is displayed in the second display area 24B within the first sidebar 24 and by the video display device 4. The device 6 proceeds from either step 10.6 or step 10.10 to step 10.12 to perform other operations. It is understood that the device 6 may return from step 10.12 to step 10.2 periodically or upon receipt of a relevant command by the user or via the network 26.

The foregoing disclosures and statements are illustrative only of the Present Invention, and are not intended to limit or define the scope of the Present Invention. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

I claim:

1. A software architecture for integrating a sidebar into a gadget, the architecture comprising:
a sidebar software configured to display a sidebar within a desktop image of a visual display of a computational system;
a gadget software configured to present the sidebar in association with a visually displayed gadget and enable actuation of at least one sidebar functionality associated with the sidebar software and at least one additional functionality; and
a graphics generator configured for rendering the sidebar in association with the gadget.

2. The architecture of claim 1, further comprising a cover flow generator, the cover flow generator configured for rendering a plurality of visual icons and wherein each visual icon enables actuation of at least one functionality associated with the gadget.

3. The architecture of claim 2, wherein the actuation of the at least one functionality comprises placing the sidebar to a foreground of the desktop image.

4. The architecture of claim 2, wherein the actuation of the at least one functionality comprises placing the gadget to a foreground of the desktop image.

5. The architecture of claim 2, wherein at least one visual icon enables actuation of the at least one sidebar functionality.

6. The architecture of claim 2, wherein at least one visual icon enables actuation of the sidebar.

7. The architecture of claim 2, wherein at least one visual icon enables actuation of the at least one additional functionality associated with the gadget.

8. The architecture of claim 7, wherein at least one additional visual icon enables actuation of the at least one sidebar functionality.

9. The architecture of claim 7, wherein at least one additional visual icon enables actuation of the sidebar.

10. The architecture of claim 2, wherein the actuation of the at least one functionality comprises running a software application associated with the at least one visual icon.

11. The architecture of claim 2, wherein the actuation of the at least one functionality comprises placing a contemporaneously open software application to a foreground of the desktop image.

12. A method for enabling a user to add to a functionality suite of a sidebar gadget, comprising: (a) rendering a gadget image within a desktop image of a display device, the gadget image enabling actuation of a sidebar set of functionality and at least one gadget functionality; (b.) displaying at least one widget icon within the desktop; and (c.) enabling the user to drag and drop the widget icon into the gadget image and in response including the at least one widget icon within the gadget image, whereby a widget functionality associated with the widget icon may be actuated by means of the sidebar gadget.

13. The method of claim 12, further comprising: (d.) displaying a plurality of widget icons within the desktop image; and (e.) enabling the user to drag and drop any of the widget icons into the gadget image and in response including a dragged and dropped widget icon within the gadget image, whereby a widget functionality associated with any dragged and dropped widget icon of the gadget image may be actuated by means of the sidebar gadget.

14. The method of claim 12, further comprising: (d.) associating at least one functionality of the sidebar set of functionality, the at least one gadget functionality and at least one widget functionality in a unique one to one correspondence with a cover icon of plurality of cover icons; and (e.) rendering the plurality of cover flow icons as a cover flow view within the desktop image.

15. The method of claim 12, further comprising: (d.) associating at least one functionality of the sidebar set of functionality and the at least one gadget functionality in a unique one to one correspondence with a function icon of plurality of function icons; and (e.) rendering the plurality of function icons and the at least one widget icon as unique icon views within the gadget image.

16. The method of claim 12, further comprising: (d.) associating at least one functionality of the sidebar set of functionality, the at least one gadget functionality and at least one widget functionality in a unique one to one correspondence with a text tag of plurality of text tags; and (e.) rendering the plurality of text tags as a list view within the gadget image.

17. A computational system comprising:
means to visually display a gadget;
means to visually display a sidebar as an aspect of the gadget; and
means to enable a user to direct the computational system to instantiate a functionality of the gadget.

18. The computational system of claim 17, further comprising means to render a cover flow view from which each functionality of a plurality of functionalities of the sidebar and the gadget may be selected and actuated by a user.

19. The computational system of claim 17, further comprising means to enable a user to add an additional functionality to the gadget by dragging and dropping a function icon associated with the additional functionality into a visual display of the gadget.

20. The computational system of claim 17, further comprising means to accept user commands that require the system to establish a communications session with a remote server in order to provides a functionality offered by the gadget, and means to establish the required communications session with a remote server.

21. The computational system of claim 20, further comprising means to at least partially satisfy at least one user command that requires the system to establish a communications session with a remote server while the computational system is offline.

22. A computer-readable medium comprising machine-readable instructions which when executed by a computational system cause the computational system to perform a method comprising:
visually associating a sidebar as an aspect of gadget; and
visually associating access to at least one additional functionality as an aspect of the gadget.
